(19) United States
(12) Patent Application Publication
(10) Pub. No.: US 2003/0232312 A1
(43) Pub. Date: Dec. 18, 2003

(54) Method and system for instantly communicating, translating, and learning a secondary language

(76) Inventors: C. McKeller Newsom, Charlotte, NC (US); Christian A. Terfloth, Charlotte, NC (US); Jennifer Lupold Pearsall, Charlotte, NC (US); Ivanna Mann Thrower, Charlotte, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/172,222

(22) Filed: Jun. 14, 2002

(51) Int. Cl. G09B 19/06; G09B 19/08

(52) U.S. Cl. 434/157; 434/156; 434/169; 434/185

(57) ABSTRACT

A method and system for translating, learning and speaking a foreign language are disclosed. The method comprises the steps of selecting a word or phrase in a known language which needs to be expressed in a foreign language, locating the word or phrase in a provided manual text, reading the manual text and a provided transition guide, and speaking the desired word or phrase in the foreign language. The system comprises a manual text comprising a plurality of pages bound together at a spine containing three columns and at least one row of text. The first column contain word(s) or phrases in a known language, the second column contains corresponding word(s) or phrases in a foreign language, and the third column contains a transition guide for aiding in the proper pronunciation of the foreign language.

### CROSS REFERENCE TO RELATED APPLICATION

This application claims the benefit of U.S. Provisional Application No. 60/298,002, filed Jun. 13, 2001.

### NOTICE OF COPYRIGHTED SUBJECT MATTER

A portion of the disclosure of this patent document contains material that is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### FIELD OF THE INVENTION

The present invention relates to a method and system for instantly translating a known language to a secondary or foreign language and ultimately communicating and learning the foreign language, and more particularly to a method of and system for instantly translating a known language to a secondary language using a step-by-step phonetic and grammar system to aid in simple sentence generation and customary conversational exchanges.

### BACKGROUND OF THE INVENTION

Learning, translating and communicating a foreign or secondary language based upon a known language is difficult for individuals in their adult years. One aspect contributing to the difficulty of learning a foreign language is that the sounds and words of the foreign language are not familiar to the user attempting to learn or speak the language. Several methods of learning foreign or secondary languages are known in the art. Methods of language instruction are typically characterized by (i) learning with a teacher in a formal setting such as a classroom, (ii) learning from audio-lingual recordings or audio-visual tapes, (iii) learning from an interactive computer software program, and (iv) learning from literature documents such as flash cards, magazines, and books. All of these methods typically require a certain level of memorization of both conjugation and vocabulary. Additionally, these methods typically require the user to commit a large quantity of time in order to achieve the level of memorization required.

In addition to the above methods, several translation methods have been used in the past. However, these methods have proven to be ineffective as they rely on word for word translation. Simple word for word translation often results in improper or confusing syntax, grammar, word order, and meaning in the secondary language.

Each of the existing methods for learning a secondary language has disadvantages. As briefly mentioned above, memory-dependent methods such as those mentioned above are ineffective. One problem which frequently arises with memorization methods is time. Cumulative memorization processes require long-term commitments of time by a user for both study and practice. Many users are simply unable or unwilling to invest the necessary time in learning a new language. This unwillingness stems from the fact that many users are only interested in casual use, for example, in communicating during travel or for business purposes. An additional problem with memorization methods is that as time passes without frequent use, knowledge of the subject language diminishes.

With respect to the audio-lingual recordings, the recordings teach a user by listening and speaking only. These methods are based upon the user memorizing new vocabulary via the hearing sense. Likewise, audio-visual tapes employ the hearing and visual senses by having a user watch and listen. In both methods the knowledge is built up gradually in a predetermined order and is limited to basic conversation or terminology only. No appreciation for grammar, pronunciation or syntax is taught. Moreover, the user may not have access to written text with this form of learning.

Flash cards, magazines and books are relatively inexpensive and provide a written text, but do not provide an effective system to teach a user the proper pronunciation of the language. Moreover, they typically limit the user to predetermined phrases only. No ability to generate original sentences is taught.

Concerning the use of computer software, programs have recently become available stemming from the proliferation of multi-media personal systems. These systems have the ability to combine text, sound and graphics. Again, however, a flaw with these methods are the lack of an effective instruction on pronunciation. It is appreciated that it is sometimes difficult for a user to ascertain how to correctly pronounce a word or phrase simply by hearing the word or phrase spoken. Additionally, multi-media software packages can be expensive. User's seeking to gain only a casual use of a secondary language are not willing to invest the funds necessary to purchase such software. Thus, while advances have been made, computer software has yet to satisfy the objects stated herein.

Traditional dictionaries and self study guides provide such large quantities of lexical information that users are often overwhelmed by the sheer volume of selections and the time it takes to locate particular words. Phonetic transcriptions in dictionaries and self study guides are often difficult to read and vocalize. Supplemental instructions on how to use those systems are difficult to access, typically being located in a separate section of the guide or dictionary. When the appropriate section is finally found, the user faces difficult instructions that apply on a case by case, or word by word, basis. The resultant effect is a low quality of pronunciation.

By reviewing the related art, it is readily apparent that an inexpensive, easy to use, step-by-step, translating and learning method is needed for basic sentence generation and conversational exchanges of secondary languages. Accordingly, the principal objects of this invention stated below exist and, as will be clearly seen by this invention, are satisfied.

### DESCRIPTION OF THE PRIOR ART

Applicant is aware of the following U.S. Patents concerning methods of translating and teaching secondary languages:

| U.S. Pat. No. | Inventor | Issue Date | Title |
|---|---|---|---|
| 4,112,595 | Fernandez, et al. | September 1978 | Teaching devices |
| 5,178,542 | Chigrinsky, et al. | January 1993 | Learning aid |
| 5,486,111 | Watkins | January 1996 | Foreign Language teaching aid |
| | | | and method |
| 5,487,670 | Leonhardt | January 1996 | Dynamic language training |
| | | | system |
| 5,649,826 | West, et al. | July 1997 | Method and device for |
| | | | teaching language |
| 5,735,693 | Groiss | April 1998 | Method and device for |
| | | | learning a foreign language |
| 5,738,523 | Wagoner, et al. | April 1998 | Written composition teaching |
| | | | methods and aids therefor |
| 5,788,502 | Shea | August 1998 | Method of language |
| | | | instruction and fact |
| | | | recognition |
| 5,882,202 | Sameth, et al. | March 1999 | Method and system for aiding |
| | | | foreign language instruction |
| 6,024,571 | Renegar | February 2000 | Foreign language |
| | | | communication system/device |
| | | | and learning aid |
| 6,045,363 | Phillips | April 2000 | Educational aid and method |
| | | | for using the same |

### SUMMARY OF THE INVENTION

This invention provides a method and system for instantly translating and communicating a known language to a secondary or foreign language and ultimately learning the foreign language. The present invention is useful in many different situations, but is particularly useful for individuals who only wish to learn or communicate a foreign language for casual use, including leisure travel and business communications. The method and system provides instant access to a foreign language's terminology and grammar, including predetermined phrases and a process for originating sentences on a step by step basis by providing instant phonetic and instant grammar aids. Moreover, the present invention provides an innovative pronunciation guide to assist users in properly pronouncing both words and phrases. The present invention is preferably embodied in a manual text document which provides a translation system in which linguistic components are grouped and displayed. However, other embodiments such as a readable text in a software format are able to be utilized.

In the present invention, several key aspects of translation needs are addressed via methods that are system oriented. The need for memorization is replaced by a method for rapidly accessing words and phrases. The need for knowledge of syntax is also replaced by providing lexical data in sequentially aligned frameworks. The framework serves as a flow chart for the sentence structure. Clarification of grammatical variations between languages are provided by brief notations. Finally, an innovative pronunciation guide is provided in order to ensure that the user properly pronounces selected words and phrases.

During normal operation, as a user attempts to communicate with an individual by using a foreign language he first finds the word or words which he wishes to speak in a known language contained in a provided manual text and simply reads and speaks the phonetic transition corresponding to the syllables and words of the secondary or foreign language. In order to ensure that the proper pronunciation is used, the user must consult the provided transition which gives the user innovative pronunciation hints. Additionally, in order to ensure that proper grammar is used, the user simply has to consult brief notes which are provided.

The innovative pronunciation hints comprise several basic guides. First, some hints will utilize rhyming. Others will use association. Still others will use alphabetical or numerical hints. Still others will use accent, word breaks or capitalization hints.

Finally, by active involvement, casual review, repetitive use and exposure, and incidental contact, the user acquires an increased knowledge and proficiency of the secondary language without the commitment of time required for the above referenced memorization methods. Thus, a level of learning is also achieved without a long-term time commitment of study.

### OBJECTS OF THE INVENTION

The principal object of the present invention to serve as a communicating, translating and learning aid. The present invention serves as a learning aid in a number of ways. Stationary displays of words and phrases in simplified modules are provided and easily accessed for use in conversation and for purposes of review and study. Additionally, displays of secondary language translation data are grouped in tangibly fixed, user friendly format that encourages casual review.

It is a further object of the present invention to provide an innovative grammar guide which assists a user in properly forming sentences in a foreign language.

It is a further object of this invention to provide an innovative pronunciation guide which works in conjunction with the method and system so as to ensure that the user properly pronounces each word or phrase.

It is a further object of the present invention is to serve as a communication tool. The invention provides secondary language translation data in a manner such that the data may be sequentially accessed with such speed that the user may rely on the invention, rather than his/her memory of vocabulary and grammar, as a primary source of support in conversational exchanges.

Thus, through a combination of active involvement, casual review and repetitive exposure the user may experience improved proficiency in the secondary language.

These and other objects of the present invention will become readily apparent upon further review of the following specification and drawings.

### BRIEF DESCRIPTION OF THE DRAWINGS

The foregoing and other objects will become more readily apparent by referring to the following detailed description and the appended drawings in which:

FIG. 1 is a block diagram depicting the method of translating a known language into a foreign language and correctly speaking the same in accordance with the present invention.

FIG. 2 is an exemplary pictorial representation of the manual text which is provided by the present invention.

### DETAILED DESCRIPTION

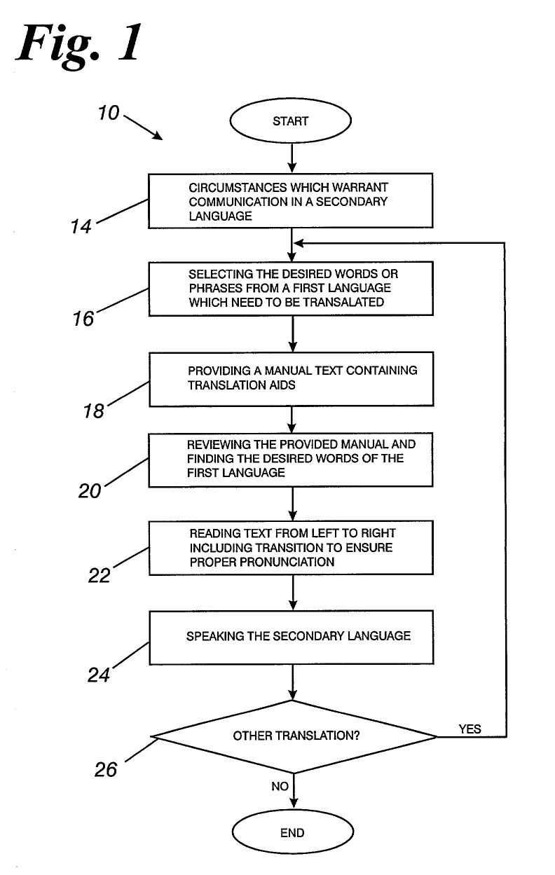

Referring now to the drawings, and particularly to FIG. 1, the invented method 110 is shown. FIG. 1 illustrates a method 10 by which a user may learn, translate, communicate a known language 50 into a foreign language 52. For the purposes of this disclosure and the claims, the term “foreign language” refers to any unfamiliar spoken language in which a person has an interest in translating or learning, and is not meant to refer to nationality. Furthermore, for the purposes of illustration only, examples presented herein are using English as the known and first language 50 and Spanish as the foreign or secondary language 52. It is appreciated that any spoken language may be used for either the first or second language 50 and 52, respectively, including, but without limitation all Latin based languages, all Scandinavian Languages, all Germanic Languages, all Romance Languages, Asian Languages, Greek, Russian, Arabic, etc.

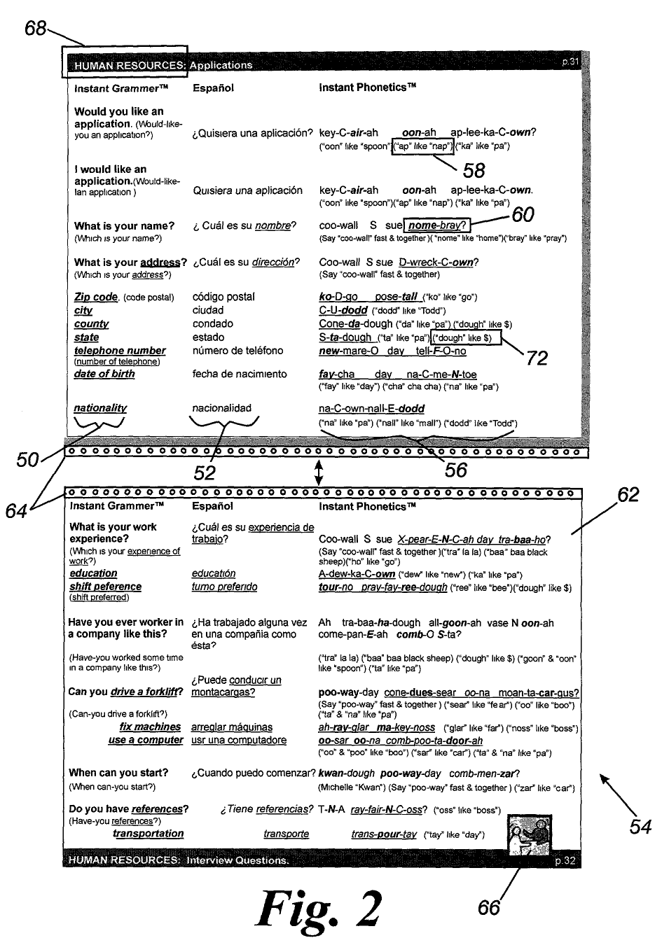

According to this method 10, a user is presented with a set of circumstances which warrant communication in a foreign or secondary language 52 at Block 14. At Block 16, the user chooses a word or phrase in the known language 50 which he wishes to translate and speak in the foreign language 52. Thereafter, at Block 18, the user is provided with a manual text 54 containing transition aids 56. The manual text 54 is described more completely in FIG. 2.

Referring now to FIG. 2, a pictorial diagram of the text manual 54 used in accordance with the present method 10 is shown. The text manual 54 visually provides the known language vocabulary 50, the transition 56 and the corresponding foreign language vocabulary 52 displaced between the known language vocabulary 50 and the transition 56. The transitions 56 may include pronunciations 58 of the foreign language vocabulary 52 that aid the user in learning the correct pronunciations of the foreign language vocabulary 52. The method 10 may also present sentence completion exercises to the user that aid in teaming correct spelling and usage of the foreign language 52. The transition aids 56 of the foreign language vocabulary 52 include phonetic pronunciation syllables 60 written in the known language and corresponding to the foreign language 52.

The text manual 54 which is provided for by the method 10 is formed of one or more pages 62 bound together along a spine 64. As used herein, the term “manual” refers to any multi-page book, pamphlet, magazine, booklet, palm held reading device, software program, web page or the like. Each page 62 incorporates text and, in some cases, complementary artwork 66. As used herein, the term “artwork 66” contemplates, in addition to drawings and the like, other printed material of a non-textual nature of any form, such as graphic designs and the like, placed on the page 62 for consideration in conjunction with the text. As shown in FIG. 2, a preferred embodiment of the present invention is a format wherein the letters of the text are in a stylized font. Moreover, the “artwork 66” provided is of a comic or cartoon nature. It is appreciated that numerous other formats can be used, for example, a professional font on a “comic book” type font accompanied by photographs, artists drawings or clip art.

With respect to FIG. 2 itself, the pictorial representation shows two pages 62 of the manual 54 having modules 68 written thereon. These modules 68 consist of the text and, in some instances, the artwork 66. More specifically, these modules 68 consist of groups of words and phrases that are related by topic. They are organized so as to allow a user to form sentences and use correct grammar. For example, some modules are organized by first presenting a question and having various answers provided thereunder. Each module 68 is comprised of at least three columns and at least one row of words. The first column consists of the known language vocabulary 50. The third column consists transition 56. The second column, which is displaced between the first and third columns, consists of the corresponding foreign language vocabulary 52. Finally, the pronunciation hints 58 and optional artwork 66 are strategically placed throughout the module 68 so as to aid in the translation of the selected text. Grammar aids are optionally added to the first and third columns so as to ensure proper sentence structure.

Referring again to FIG. 1, at Block 20, the provided text manual 54 is reviewed in a manner which allows the user to locate the pre-selected word or phrase. At block 22, the user reads the provided text manual 54 from the left to right. Particularly, the user reads the transition 56. The transition 56 is a guide to correctly pronouncing the selected word or phrase. The transition 56 is comprised of syllables and words in the foreign language 52 which are phonetically written in the known language 50.

In addition to the phonetic syllables 60, the pronunciation hints 58 are provided to further assist the user in properly translating and pronouncing the known words 50 to the foreign words 52. These innovative pronunciation hints 58 have several embodiments, to which one or all can be utilized in or as a transition 56. In one embodiment, Rhyming hints are used. Rhyming hints consist of providing the user with a word in the known language 50 which rhymes with a syllable in the foreign language 52. For example, if the word “six” wishes to be spoken, the method and system would provide the following rhyming or associative hint:

“Sace” like “face” (“seis” in Spanish=“six” in English)

“Oon Poe-ko” (“oon” like “spoon”; Edgar Allan “Poe”; “ko” like “go”)

(“Un Poco” in Spanish is “A little” in English)

Another embodiment of the innovative hints is Alphabet Letter Hints. These hints are letters of the known language 50 meant to serve as a pronunciation of a syllable in the foreign language 52. For example, if the user wishes to speak the word “patio” the hint would be as follows:

“Pa-T-O” (“patio” in Spanish=“patio” in English)

Further some Alphabet hints utilize apostrophes. These hints should be pronounced as they are in the known language 50. For instance, if the selected phrase is “want(you)?”, the following hint would be used:

“Key-air-A's” (A's is pronounced as you would say: “I made all A's”.)

(“Quieres?” in Spanish=“Want(you)?” in English)

Still another embodiment of the innovative hints are Number hints. Number hints are to be pronounced as they are in the known language 50. For example:

“S-2-D-R” (“estudiar” in Spanish=“to study” in English)

Still another embodiment of the innovative hints are Accent Hints. These hints are comprised of italicized, highlighted or colored letters, numbers, or the like to place emphasis on a particular syllable. For example:

“Man-10-E-me-N-toe” (“mantenimento” in Spanish=“maintenance” in English)

“B-N” The accent is on the “N” (“bien” in Spanish=“good” in English)

Still other embodiments of the innovative hints are Word Break hints and Capitalized Proper Nouns Hints. With Capitalized Proper Nouns Hints the capital letters for proper nouns indicate that the word should be pronounced like the proper noun would be pronounced in the known language 50. Further, Word Breaks are indicated by a space in between the words, letters and numbers, whereas syllable breaks are indicated by the (-) between the letters, words, and numbers. For example:

“B-N tar-daze” (“bien tardes” in Spanish=“good afternoon” in English)

Still another embodiment of the innovative hints are graphical hints 72. These hints are comprised of typographical symbols and the like to serve as a pronunciation of a syllable or word. For example:

S-ta-dough (“ta” like “pa”) (“dough” like “$”)

(“estado” in Spanish=“state” in English)

At Block 24, the user simply speaks the selected word in the foreign language 52 in accordance with the provided transition 56. Thereafter, at Block 26, a determination is made as to whether a new word or phrase needs to be spoken. If the answer to the query is in the affirmative, then the foregoing steps are repeated. If, however, the answer is in the negative, then the process is complete.

In addition to the transition 56 and the artwork 66, grammatical and syntaxical guides are provided. These guides are strategically placed in the modules 68 throughout the manual text 54. For example:

I no need tool green=I don't need the green tool=Yo no necesito herramienta verde

Teaches the grammar concept of noun before adjective without the person having to study grammar.

Of nothing=You're Welcome=De nada

Teaches that “De” means “of” and “nada” means “nothing”.

Pass a good end of week=Have a nice weekend=Pase un buen fin de semana

Instant grammar adds humor and serves as a mnemonic device.

Where it put-I?=Where do I put it?= [symbol] Donde lo pongo?

Easily demonstrates the grammar concept of using pronouns as endings.

Finally, the method and system 10, provides a complimentary response translation device (not shown). The response translation device, is part of the manual text 54 and can be provided by the user to the recipient so that a response to a specific query or comment can be made in the known language 50. This response translation device allows for easy two way communication because it supplies predetermined answers to queries. The primary and secondary language are switched in location and corresponding hints are provided to help in translation in the same manner as described above.

### SUMMARY OF THE ACHIEVEMENT OF THE OBJECTS OF THE INVENTION

From the foregoing, it is readily apparent that we have invented a method and system which serves as a communicating, translating and learning aid. The present invention serves as a learning aid by utilizing stationary displays of words and phrases in simplified modules which are easily accessed for use in conversation and for purposes of review and study. The present invention serves as a translation aid by providing displays of secondary language translation data that are grouped in a tangibly fixed, user friendly format so that casual review is encouraged.

It is a further apparent that we have invented a method and system which uses an innovative pronunciation guide which works in conjunction with the method so as to ensure that the user properly pronounces each word or phrase.

Finally, it is apparent that we have invented a method and system which allows an increased level of proficiency in a secondary language on the part of the user through a combination of active involvement, casual review and repetitive exposure.

It is to be understood that the foregoing description and specific embodiments are merely illustrative of the best mode of the invention and the principles thereof, and that various modifications and additions may be made to the system and method by those skilled in the art, without departing from the spirit and scope of this invention.

What is claimed is:

1. A method for translating and concurrently learning a spoken language, said method comprising the steps of:
providing a readable text for translating and teaching a given language to a user, said readable text comprising a plurality of columns and rows of words and phrases of a primary language, corresponding words and phrases from a secondary language, a phonetically based pronunciation guide for translating said primary words and phrases to said corresponding secondary words and phrases, and grammatical notes on the use of said secondary words and phrases located periodically throughout said readable text;
exposing the user to said readable text; and
assigning predetermined guides lines for phonetically pronouncing selected syllables of said words of the secondary language;
wherein the user translates said primary language word or phrase to the secondary word or phrase by reading said readable text of said pronunciation guide and speaking said secondary word.

2. The method according to claim 1 wherein the pronunciation guide comprises words of the primary language which correspond and rhyme with syllables of the selected secondary language word.

3. The method according to claim 1 wherein the pronunciation guide comprises numerals of the primary language which correspond to syllables of the selected secondary language word.

4. The method according to claim 1 wherein the pronunciation guide comprises stylized, highlighted or colored characters which indicate to the user that emphasis should be placed upon certain syllables.

5. The method according to claim 1 wherein the pronunciation guide comprises capital letters from the primary language which represents corresponding syllables of the secondary language.

6. The method according to claim 1 wherein the pronunciation guide comprises graphical symbols which represents corresponding syllables or words of the secondary language.

7. The method according to claim1 wherein the pronunciation guide comprises a combination of elements selected from the group consisting of rhyming hints, associative hints, numerical hints, stylized hints, graphical hints and capital letter hints.

8. A system for translating and concurrently learning a spoken language comprising:
a manual text comprising a series of pages bound together at a spine;
a plurality of primary language words in text format placed on the pages forming a column;
a plurality of secondary language words in a text format placed on the pages forming a second column, said plurality of secondary language word organized so as to be in corresponding order with said primary language words;
a plurality of pronunciation guides written in a text format on the pages forming a third column, said transitions being correspondingly organized and placed adjacent said secondary language words;
a plurality of artwork drawn and placed periodically throughout said pages; and
a plurality of grammatical notes written in the primary language words placed periodically throughout said pages.

9. The system according to claim 8 wherein the pronunciation guide comprises words of the primary language which correspond and rhyme with syllables of the selected secondary language word.

10. The system according to claim 8 wherein the pronunciation guide comprises numerals of the of the primary language which correspond to syllables of the selected secondary language word.

11. The system according to claim 8 wherein the pronunciation guide comprises stylized characters which indicate to the user that emphasis should be placed upon certain syllables.

12. The system according to claim 8 wherein the pronunciation guide comprises capital letters from the primary language which represents corresponding syllables of the secondary language.

13. The system according to claim 8 wherein the pronunciation guide comprises graphical symbols which represents corresponding syllables or words of the secondary language.

14. The system according to claim 8 wherein the pronunciation guide comprises a combination elements selected from the group consisting of rhyming hints, associative hints, numerical hints, stylized hints and capital letter hints.

15. The system according to claim 8 wherein a response translation companion is provided; said companion comprising predetermined responses in the secondary language to provided queries of the primary language and a corresponding pronunciation guide for translating the secondary language to the primary language.
